(19) United States
(12) Patent Application Publication
(10) Pub. No.: US 2016/0275384 A1
(43) Pub. Date: Sep. 22, 2016

(54) APPARATUS, SYSTEM, AND METHOD FOR CREATION OF CUSTOM MEDICATION LABELS

(71) Applicant: Xerox Corporation, Norwalk, CT (US)

(72) Inventors: Linn C. Hoover, Webster, NY (US); William J. Hannaway, Webster, NY (US)

(21) Appl. No.: 14/662,560

(22) Filed: Mar. 19, 2015

(51) Int. Cl. G06K 15/02; H04N 1/00; G06F 3/12

(52) U.S. Cl. CPC G06K 15/1819; G06K 15/1815; G06F 3/1243; H04N 1/00251

(57) ABSTRACT

A computer-based apparatus for creating custom medication labels, including: a memory element configured to store, medication information, patient information, and a plurality of medication label configurations; and a processor for a computer configured to receive a first input selecting the medication information, the patient information, and a medication label configuration from the plurality of medication label configurations, receive a second input including a patient photograph, create, according to the medication label configuration, a custom medication label including the medication information and the patient information, identify a silhouette from the patient photograph, create instructions for cutting a portion of the custom medication label to in represent the silhouette, and transmit the custom medication label and the instructions.

### TECHNICAL FIELD

The present disclosure relates to an apparatus, system, and method for using medication information, patient information, a label configuration, and a photograph of a patient to create a custom medication label. A silhouette of the patient is identified from the patient photograph, and a portion of the custom medication label is cut, as represented by the silhouette.

### BACKGROUND

Medication adherence, including patient adherence to medication regimens, is an important aspect of any system providing medical services. This is particularly true in a veterinary medical setting, as the patient taking the medication cannot administer the medication to itself, and all medications must be administered by a human caretaker. This complete reliance by patients on caretakers is a unique feature of the veterinary medical setting, and unlike in the human medical setting, the patient can provide no guidance to the caretaker on how or which medicine should be administered. Additionally, a single animal patient may have multiple human caretakers, some of whom may not regularly administer medicine to the animal patient, such as when a relative takes care of a family member's pet.

In light of these unique features of the veterinary medical setting, it is critical that medication adherence be encouraged through means available to all caretakers. Further, information relating to the medication should be easy to parse and understand by the human caretakers, as they may be inexperienced in administering medication to a specific patient.

### SUMMARY

According to aspects illustrated herein, there is provided a computer-based apparatus for creating custom medication labels, including a memory element configured to store, medication information, patient information, a plurality of medication label configurations, and a processor for a computer configured to receive a first input selecting the medication information, the patient information, and a medication label configuration from the plurality of medication label configurations, receive a second input including a patient photograph, create, according to the medication label configuration, a custom medication label including the medication information and the patient information, identify a silhouette from the patient photograph, create instructions for cutting a portion of the custom medication label to represent the silhouette, and transmit the custom medication label and the instructions.

According to aspects illustrated herein, there is provided a computer-based method for creating medication labels, including storing, using a memory element, medication information, patient information, and a plurality of medication label configurations, receiving, on a processor, a first input selecting the medication information, the patient information, and a medication label configuration from the plurality of medication label configurations, receiving, on the processor, a second input including a patient photograph, creating, using the processor and according to the medication label configuration, a custom medication label including the medication information and the patient information, identifying, using the processor, a silhouette from the patient photograph, creating, using the processor, instructions for cutting a portion of the custom medication label to represent the silhouette, and, transmitting, using the processor, the custom medication label and the instructions.

According to aspects illustrated herein, there is provided a computer-based apparatus for creating custom medication labels, including a memory element configured to store medication information, patient information, and a plurality of medication label configurations, a processor for a computer configured to receive a first input selecting the medication information, the patient information, and a medication label configuration from the plurality of medication label configurations, receive a second input including a patient photograph, create, according to the medication label configuration, a custom medication label including the medication information and the patient information, identify a silhouette from the patient photograph, create instructions for cutting a portion of the custom medication label to represent the silhouette, and transmit the custom medication label and the instructions, a printer arranged to receive the custom medication label, and print the custom medication label, and a cutter arranged to receive the instructions from the processor and cut a portion of the custom medication label according to the instructions.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a schematic illustration of a computer-based apparatus for creating custom medication labels;

FIG. 1B is a block diagram of a computer-based apparatus for creating custom medication labels;

FIG. 2 is a flow chart representing the steps in a computer-based method for creating a custom medication label;

FIG. 3 is a schematic representation of a method for identifying a silhouette and creating instructions for cutting the silhouette using the computer-based apparatus of FIGS. 1A and 1B;

FIG. 4 is a front view and a side view of an example completed custom medication label, showing the relationship between the panels of the custom medication label; and,

FIG. 5 is a front view of an example custom medication label with an extended silhouette.

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodology, materials and modifications described and as such may, of course, vary. It is also understood that the terminology used herein is for the purpose of describing particular aspects only, and is not intended to limit the scope of the disclosed embodiments, which are limited only by the appended claims.

Unless defined otherwise, all technical, mathematical, and scientific terms used herein have the same meaning as commonly understood to one of ordinary skill in the art to which these embodiments belong. As used herein, by “computer” it is generally meant any analog or digital electronic device which includes a processor, memory, and/or a storage medium for operating or executing software or computer code. As used herein, by “medication information” it is generally meant information pertaining to the attributes of a specific medication, such as instructions for administering, dosages, contraindications with certain conditions or other medications, warnings, and similar information. As used herein, by “patient information” it is generally mean information pertaining to the attributes of a specific patient, such as species, age, weight, breed, medical history, owner/caretaker name, and other identifying information, such as patient address, patient tag number, and owner/caretaker phone number. As used herein, by “medication label configuration” it is generally meant a description or representation of the structure of the label, for example, the physical space or surface available for printing. For example, a medication label configuration can include two-dimensional data, such as size and shape of the label as a whole or of the individual parts of the label. As further described below, a medication label configuration also can include three-dimensional information such as protrusions or recesses on or in a surface which must be accommodated by a label, or surface or textural information such as indicia on a surface that also must be accommodated by a label. A medication label configuration may be stored as a digital representation of such data for instance, in a memory element of a computer. As used herein, by “photograph” it is generally meant a visual representation of a scene as captured by a camera. A photograph may be stored as a physical photographic print or as a digital file, for instance, in a memory element of a computer. A photograph may be initially captured by a digital camera or a physical photographic print may be scanned and stored as a digital file. As used herein, by “silhouette” it is generally meant a two-dimensional path describing an outline of a surface that includes only or substantially only the subject of the silhouette.

Moreover, although any methods, devices or materials similar or equivalent to those described herein can be used in the practice or testing of these embodiments, some embodiments of methods, devices, and materials are now described.

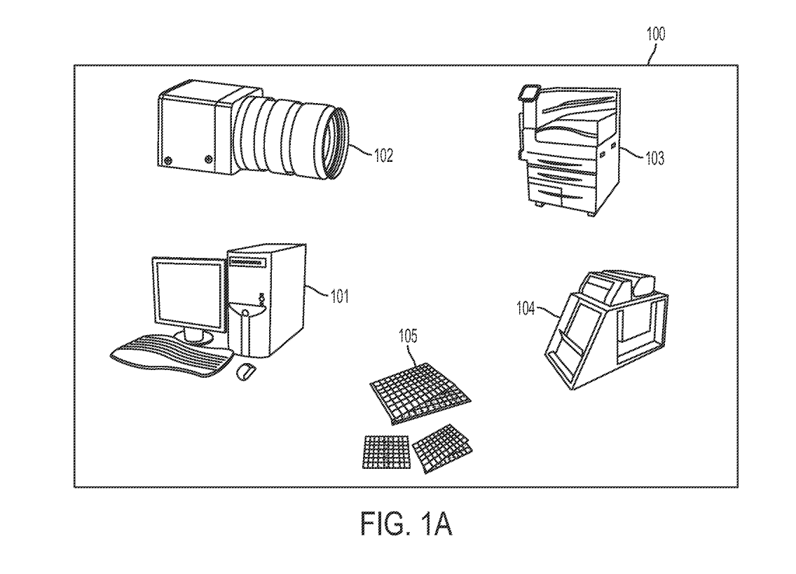

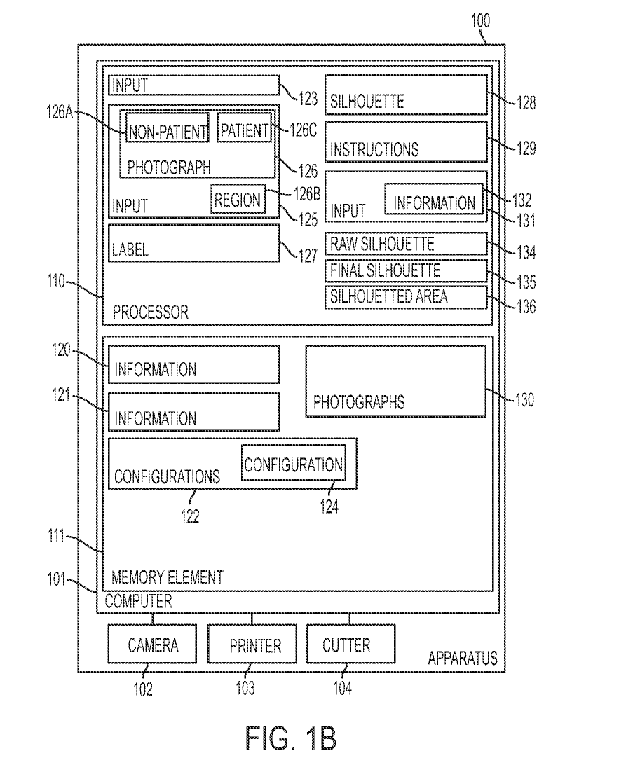

Referring now to the figures, FIG. 1A is a schematic illustration of computer-based apparatus 100 for creating custom medication labels.

FIG. 1B is a block diagram of computer-based apparatus 100 for creating custom medication labels. The following should be viewed in light of FIGS. 1A and 1B. Apparatus 100 includes computer 101 with processor 110 and memory element 111. Memory element 111 is configured to store medication information 120, patient information 121, and possible medication label configurations 122. Processor 110 is configured to: receive input 123 via computer 101; select the medication information, the patient information, and medication label configuration 124 from possible medication label configurations 122; receive input 125, via computer 101, including patient photograph 126; create, according to medication label configuration 124, custom medication label 127 including medication information 120 and patient information 121; identify silhouette 128 from the patient photograph 126; create instructions 129 for cutting a portion of the custom medication label to represent the silhouette; and transmit custom medication label 127 and instructions 129.

In an example embodiment, apparatus 100 includes camera 102 arranged to capture patient photograph 126 and transmit input 125, including patient photograph 126, to processor 110. Camera 102 can be any camera or image capture device known in the art, but in an example embodiment, camera 102 is a digital camera. Memory element 111 is configured to store possible patient photographs 130 and processor 110 is configured to transmit possible patient photographs 130 for display. Further, input 125 received on processor 110 may include a selection of a specific patient photograph from possible patient photographs 130.

In an example embodiment, apparatus 100 includes printer 103 arranged to receive custom medication 127 label from processor 110 and print completed custom medication label 127. The completed custom medication label may be printed on any substrate known in the art, such as paper or cardstock.

In an example embodiment, apparatus 100 includes cutter 104 arranged to receive instructions 129 for cutting a portion of completed custom medication label 127 from processor 110 and to cut a portion of the completed custom medication label according to instructions 129. Cutter 104 may also cut multiple portions of completed custom medication label 127 according to instructions 129. In addition to cutting portions of completed custom medication label according to instructions 129 to represent silhouette 128, cutter 104 may cut further portions of a completed custom medication label, for instance, to create openings for one or more of medication blister packs 105 for incorporation with completed custom medication label, or to create indicia on completed custom medication label.

Silhouette 128 may be identified by processor 110 using any appropriate image processing techniques known in the art. In an example embodiment, identifying silhouette 128 involves determining, using processor 110, at least one non-patient area 126A of patient photograph 126. Non-patient areas of patient photograph 126 may be identified by the presence of a preset or pre-known value in patient photograph 126. In an example embodiment, the preset value is a specific color, as in the well-known technique of Chroma key. The non-patient areas of patient photograph 126 may also be identifiable by identifying contrasting areas in patient photograph 126, such as areas in which the respective predominating color or brightness differ significantly, and then determining a border between such contrasting areas. In an example embodiment, processor 110 is configured to identify a non-patient area of patient photograph 126 by excluding at least one region corresponding to a feature of patient photograph 126 identified as a patient anatomical feature, such as eyes, nose, ears, etc. Processor 110 may also receive input 125 in the form of a suggested region 126B of patient photograph 126 from which silhouette 128 should be identified. For example, the input received by processor 110 may indicate that silhouette 128 should be identified from a region of patient photograph 126 corresponding to the patient's head.

Once silhouette 128 has been identified by processor 110, the silhouette may be applied to patient photograph 126 to create a silhouetted area of the patient photograph. This silhouetted area can be used, with one or more possible medication label configurations 122, to determine a best placement of patient photograph 126 on the completed custom medication label, resulting in processor 110 modifying the custom medication label 127. For instance, if the silhouetted area of patient photograph 126 would exceed the boundaries of the physical substrate on which custom medication label 127 is printed by printer 103, processor 110 is configured to scale down the size of or reposition the silhouetted area of patient photograph 126 and thereby modify the custom medication label. In an example embodiment, processor 110 receives input 131 in the form of silhouetted area transformation information 132. Silhouetted area transformation information 132 includes information that determines the location and size of the silhouetted area of patient photograph 126 on the completed custom medication label.

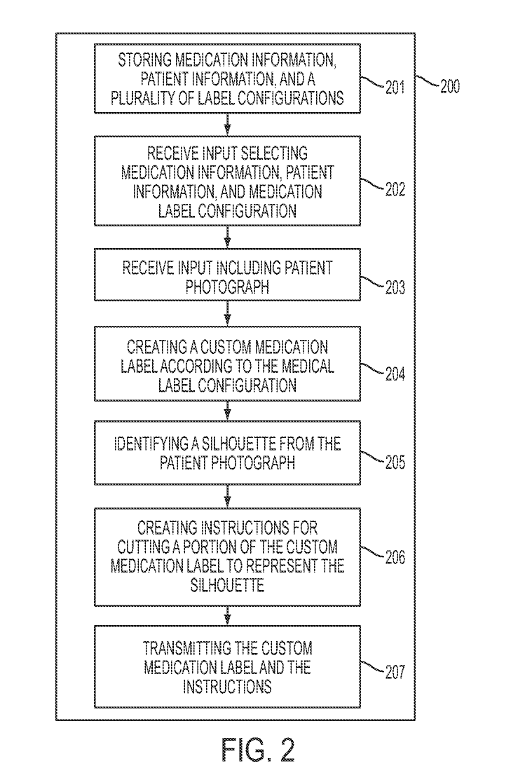

FIG. 2 is a flow chart representing the steps in computer-based method 200 for creating a custom medication label. Although the method in FIG. 2 is depicted as a sequence of numbered steps for clarity, no order should be inferred from the numbering unless explicitly stated. The following should be viewed in light of FIGS. 1A through 2. Step 201 stores, using a memory element, medication information, patient information, and medication label configurations. Step 202 receives, on a processor, a first input selecting the medication information, the patient information, and a medication label configuration from the medication label configurations. Step 203 receives, on the processor, a second input including a patient photograph. Step 204 creates, using the processor and according to the medication label configuration, a custom medication label including the medication information and the patient information. Step 205 identifies, using the processor, a silhouette from the patient photograph. Step 206 creates, using the processor, instructions for cutting a portion of the custom medication label to represent the silhouette. Step 207 transmits, using the processor, the custom medication label and the instructions.

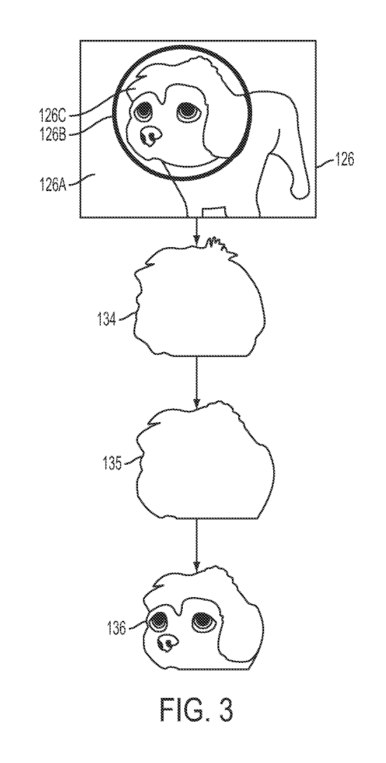

FIG. 3 is a schematic representation of a method for identifying a silhouette and creating instructions for cutting the silhouette using apparatus 100 of FIGS. 1A and 1B. Patient photograph 126 is received by processor 110, as discussed above. Patient photograph 126 includes at least one patient area 126C, which corresponds to the portions of the image that show the patient. Patient photograph 126 also includes at least one non-patient area 126A, which corresponds to the portions of the image that do not show the patient. In an example embodiment, suggested region 126B is received by the processor as part of input 125, as described above. Suggested region 126B comprises the portion of patient photograph 126 from which the silhouette should be identified.

As discussed above, the silhouette may be identified by the processor using any appropriate image processing techniques known in the art. Raw silhouette 134 is the silhouette as determined by the processor after identifying the border between at least one patient area 126C and at least one non-patient area 126A within suggested region 126B. However, as the silhouette is to be used to create instructions for the cutter, and the cutter has certain physical limitations, such as a minimum cutting radius, a minimum cutting distance, and a minimum area of cut portions, the processor can transform raw silhouette 134 into final silhouette 135. Final silhouette 135 represents a cutting path that is capable of being cut by the cutter. In an example embodiment, final silhouette 135 is a vectorized path, and instructions 129 created by the processor also comprise a vectorized path. In an example embodiment, final silhouette 135 is equivalent to raw silhouette 134. Silhouetted area 136 is the area of patient photograph 126 that is contained within final silhouette 135.

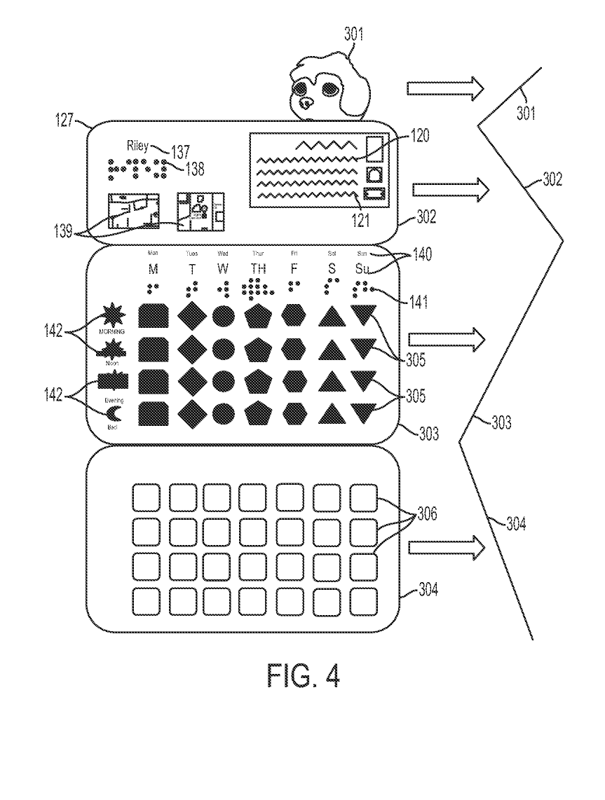

FIG. 4 is a front view and a side view of an example completed custom medication label 127, showing the relationship between the panels of completed custom medication label 127. Completed custom medication label 127 comprises silhouette panel 301, top panel 302, upper medication panel 303, and lower medication panel 304. Completed custom medication label 127 and component panels, silhouette panel 301, top panel 302, upper medication panel 303, and lower medication panel 304, are all located on a single sheet of a substrate material. Silhouette panel 301 has printed upon it, by printer 103, the portion of the patient photograph within the borders of silhouette 128 identified by processor 110. In an example embodiment, silhouette panel 301 is not printed upon by the printer and remains blank. Silhouette panel 301 is cut by the cutter in accordance with instructions 129 transmitted by the processor, resulting in silhouette panel 301 having a perimeter substantially identical to the silhouette identified by the processor.

Top panel 302 has printed upon it by the printer various indicia corresponding to medication information 120 and patient information 121. In an example embodiment, patient name 137, Braille patient name 138, at least one map 139 that shows the location of the patient's veterinary clinic, and medication information 120, patient information 121 are printed on top panel 302. Medication information 120 and patient information 121 may include information such as: patient age, weight, species, and breed; and medication information, such as administering instructions, warnings, dosages, and how to obtain refills of the medication.

Upper medication panel 303 has printed upon it by printer 103 various indicia relating to how the medication should be administered. In an example embodiment, upper medication panel 303 has printed upon it days of the week 140 and Braille days of the week 141. In an example embodiment, cutter 104 is used to remove portions of upper medication panel 303 to create indicator ports 305, such that individual blisters in medication blister pack 105 included with completed custom medication label 127 can pass through indicator ports 305 when the medication blister pack is arranged within completed custom medication label 127.

Indicator ports 305 may be shaped to convey information about how the medication should be administered, for example, indicator ports 305, through which the medication to be administered on Wednesday passes, may be shaped like circles, whereas indicator ports 305, through which the medication to be administered on Thursday passes, may be shaped like pentagons. Cutter 104 may be used to remove portions of upper medication panel 303 to create a plurality of time of day indicators 142. Time of day indicators 142 are arranged to convey what time of day the medication in adjacent or laterally adjacent individual blisters should be taken.

In an example embodiment, lower medication panel 304 has medication ports 306 through which medication contained in individual blisters in the medication blister pack can be expelled when the medication blister pack is arranged within completed custom medication label 127.

In an example embodiment, completed custom medication label 127 can be folded along the borders between silhouette panel 301, top panel 302, upper medication panel 303, and tower medication panel 304, such that, from a side view, the folds in custom medication label 127 resemble those of an accordion. In this way, medication blister pack 105 can be inserted between upper medication panel 303 and lower medication panel 304, such that the individual blisters in the medication blister pack pass through indicator ports 305 in upper medication panel 303 and medicine removed from the medication blister pack can be expelled through medication ports 306 in lower medication panel 304. In an example embodiment, both the front and rear sides of silhouette panel 301, top panel 302, upper medication panel 303, and lower medication panel 304 may be printed upon by printer 103.

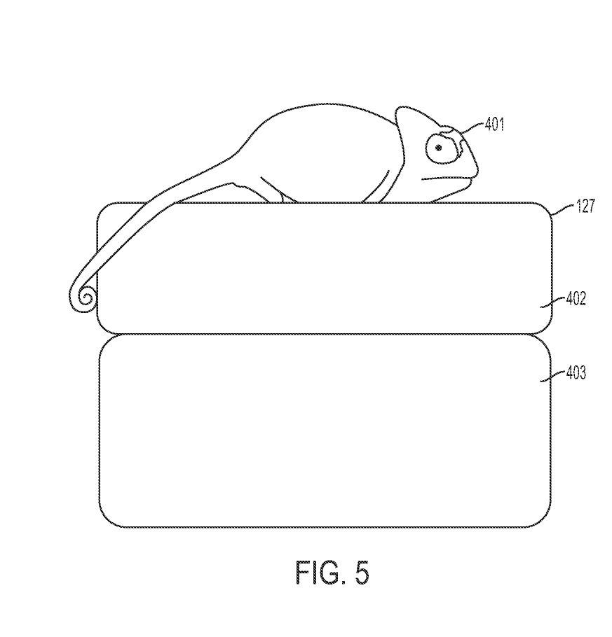

FIG. 5 is a front view of an example custom medication label 127 with an extended silhouette comprising silhouette panel 401, top panel 402, and upper medication panel 403. The silhouette area of the patient photograph extends from silhouette panel 401 to top panel 402. In this way, a portion of top panel 402 is printed by printer 103 with a portion of patient photograph 126, and cutter 104 cuts a portion of top panel 402 in accordance with received instructions 129.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-based apparatus for creating custom medication labels, comprising:
a memory element configured to store:
medication information;
patient information; and,
a plurality of medication label configurations; and,
a processor for a computer configured to:
receive a first input selecting the medication information, the patient information, and a medication label configuration from the plurality of medication label configurations;
receive a second input including a patient photograph;
create, according to the medication label configuration, a custom medication label including the medication information and the patient information;
identify a silhouette from the patient photograph;
create instructions for cutting a portion of the custom medication label to represent the silhouette; and,
transmit the custom medication label and the instructions.

2. The computer-based apparatus of claim 1, further comprising:
a camera arranged to capture the patient photograph and transmit the second input including the patient photograph to the processor.

3. The computer-based apparatus of claim 1, further comprising:
a printer arranged to:
receive the custom medication label from the processor; and,
print the custom medication label.

4. The computer-based apparatus of claim 1, further comprising:
a cutter arranged to:
receive the instructions from the processor; and,
cut a portion of the custom medication label according to the instructions.

5. The computer-based apparatus of claim 1, wherein:
the memory element is further configured to store a plurality of patient photographs;
the processor is further configured to transmit the plurality of patient photographs for display; and,
the second input includes selection of the patient photograph from the plurality of photographs.

6. The computer-based apparatus of claim 1, wherein the silhouette is identified by determining at least one non-patient area of the patient photograph.

7. The computer-based apparatus of claim 6, wherein the at least one non-patient area is determined by identifying a preset value in the patient photograph.

8. The computer-based apparatus of claim 7, wherein the preset value is a color in the patient photograph.

9. The computer-based apparatus of claim 6, wherein the at least one non-patient area is determined by excluding at least one region corresponding to a feature of the patient photograph identified as a patient anatomical feature.

10. The computer-based apparatus of claim 1, wherein the instructions include a vectorized path around the silhouette.

11. A computer-based method for creating medication labels, comprising:
storing, using a memory element, medication information, patient information, and a plurality of medication label configurations;
receiving, on a processor, a first input selecting the medication information, the patient information, and a medication label configuration from the plurality of medication label configurations;
receiving, on the processor, a second input including a patient photograph;
creating, using the processor and according to the medication label configuration, a custom medication label including the medication information and the patient information;
identifying, using the processor, a silhouette from the patient photograph;
creating, using the processor, instructions for cutting a portion of the custom medication label to represent the silhouette; and,
transmitting, using the processor, the custom medication label and the instructions.

12. The computer-based method of claim 11, further comprising:
capturing, using a camera, the patient photograph; and,
transmitting the second input including the patient photograph to the processor.

13. The computer-based method of claim 11, further comprising:
receiving, on a printer, the custom medication label from the processor; and,
printing the custom medication label on the printer.

14. The computer-based method of claim 11, further comprising:
receiving, on a cutter, the instructions from the processor; and,
cutting a portion of the custom medication label with the cutter according to the instructions.

15. The computer-based method of claim 11, further comprising:
storing, using the memory clement, a plurality of patient photographs; and,
transmitting, using the processor, the plurality of patient photographs for display, and wherein the second input includes the plurality of photographs.

16. The computer-based method of claim 11, wherein the silhouette is identified by determining at least one non-patient area of the patient photograph.

17. The computer-based method of claim 16, further comprising:
determining the at least one non-patient area by identifying a preset value in the patient photograph; or,
determining the at least one non-patient area by excluding at least one region corresponding to a feature of the patient photograph identified as a patient anatomical feature.

18. The computer-based system of claim 17, wherein the preset value is a color in the patient photograph.

19. The computer-based method of claim 11, wherein the instructions include a vectorized path around the silhouette.

20. A computer-based apparatus for creating custom medication labels, comprising:
a memory element configured to store:
medication information;
patient information; and,
a plurality of medication label configurations;
a processor for a computer configured to:
receive a first input selecting the medication information, the patient information, and a medication label configuration from the plurality of medication label configurations;
receive a second input including a patient photograph;
create, according to the medication label configuration, a custom medication label including the medication information and the patient information;
identify a silhouette from the patient photograph;
create instructions for cutting a portion of the custom medication label to represent the silhouette; and,
transmit the custom medication label and the instructions;
a printer arranged to:
receive the custom medication label; and,
print the custom medication label; and,
a cutter arranged to:
receive the instructions from the processor; and,
cut a portion of the custom medication label according to the instructions.
